(19) United States
(12) Patent Application Publication
(10) Pub. No.: US 2009/0244753 A1
(43) Pub. Date: Oct. 1, 2009

(54) MONITORING ELEMENT FOR A MAGNETIC RECORDING HEAD AND METHOD OF MANUFACTURING A MAGNETIC RECORDING HEAD

(75) Inventor: Mutsuo Yoshinami, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/247,676

(22) Filed: Oct. 8, 2008

(30) Foreign Application Priority Data
Mar. 27, 2008 (JP) 2008-084829

(51) Int. Cl. G11B 27/36

(52) U.S. Cl. 360/31

(57) ABSTRACT

A monitoring element for a magnetic recording head makes it possible to know the form of a magnetic pole of the magnetic recording head without destroying the element. The monitoring element for a magnetic recording head is formed on a workpiece for magnetic recording heads on which element magnetic poles of the magnetic recording heads are formed. The monitoring element includes a monitoring magnetic pole formed of a same material and in a same form as the element magnetic poles and monitoring terminals that are electrically connected to the monitoring magnetic pole.

### BACKGROUND OF THE INVENTION

1. Field of the Invention

The present invention relates to a monitoring element for a magnetic recording head and a method of manufacturing a magnetic recording head.

2. Related Art

The write magnetic pole of a perpendicular magnetic head is normally inverted trapezoidal or inverted triangular in form when looking from the air-bearing surface (see Japanese Laid-Open Patent Publication No. 2005-108348 for example).

Since the form of the magnetic pole (or form of the air-bearing surface) affects the write characteristics of the magnetic head, the form needs to be carefully controlled during wafer processing where write magnetic poles are formed. However, when measuring the magnetic pole width (i.e., the upper surface width in the cross section of the magnetic pole) from the wafer upper surface according to typical methods, it is not possible to know the detailed cross-sectional form of the magnetic pole that is inverted trapezoidal or inverted triangular.

For this reason, during the wafer processing where the write magnetic poles are formed, as a means for checking the shape of the magnetic pole, observation cross sections are formed by machining positions that will form air bearing surfaces using an FIB (Focused Ion Beam) and the form of the magnetic pole is evaluated by observing such cross sections using a SEM (Scanning Electron Microscope) (see FIG. 7).

### SUMMARY OF THE INVENTION

However with the method described above, time is required to machine and observe the observation cross sections, and due to limitations on processing performance, it is difficult to provide a large number of observation points. For this reason, it is difficult to routinely grasp any tendencies for fluctuations in form across the wafer by carrying out measurement at multiple points.

In addition, since the elements used for observation are destroyed by the observation process, such elements cannot be used as products. Accordingly, there has been the problem of a corresponding drop in the number of non-defective products.

For this reason, the present invention was conceived in order to solve the problem described above and it is an object of the present invention to provide a monitoring element for a magnetic recording head and a method of manufacturing a magnetic recording head where it is possible to know the form of the magnetic pole without destroying elements.

A monitoring element for a magnetic recording head according to the present invention is formed on a workpiece for magnetic recording heads on which element magnetic poles of the magnetic recording head are formed, the monitoring element including: a monitoring magnetic pole formed of a same material and in a same form as the element magnetic poles; and monitoring terminals that are electrically connected to the monitoring magnetic pole.

The monitoring terminals may be formed of the same material as the monitoring magnetic pole.

A magnetic recording head according to the present invention includes: a magnetic pole; and a coil, wherein the magnetic pole is equipped with non-magnetic monitoring terminals that are electrically connected to the magnetic pole.

A method of manufacturing a magnetic recording head according to the present invention manufactures a magnetic recording head formed with an air bearing surface including a cross-section of a magnetic pole that has been subjected to a grinding process after formation of the magnetic pole, the method including: a step of measuring a resistance of the magnetic pole before the grinding process; a step of measuring a width of an upper edge of the magnetic pole; and a step of calculating a cross-sectional form using the width of the upper edge and the resistance of the magnetic pole.

Another method of manufacturing a magnetic recording head according to the present invention manufactures a magnetic recording head formed with an air bearing surface including a cross-section of a magnetic pole that has been subjected to a grinding process after formation of the magnetic pole, the method including: a step of measuring a resistance of the magnetic pole before the grinding process; a step of measuring a width of an upper edge of the magnetic pole; a step of measuring a film thickness of the magnetic pole; and a step of calculating a cross-sectional form using the width of the upper edge, the resistance, and the film thickness of the magnetic pole.

Here, the film thickness may be measured optically.

A method of measuring the form of a magnetic pole of a magnetic recording head according to the present invention includes: a step of measuring a resistance of the magnetic pole; a step of measuring a width of an upper edge of the magnetic pole; and a step of calculating a cross-sectional form using the width of the upper edge and the resistance of the magnetic pole.

Another method of measuring the form of a magnetic pole of a magnetic recording head according to the present invention includes: a step of measuring a resistance of the magnetic pole; a step of measuring a width of an upper edge of the magnetic pole; a step of measuring a film thickness of the magnetic pole; and a step of calculating a cross-sectional form using the width of the upper edge, the resistance, and the film thickness of the magnetic pole.

According to the monitoring element for a magnetic recording head and the method of manufacturing a magnetic recording head according to the present invention, it is possible to easily know the form of a magnetic pole without destroying the element. By fabricating a large number of dedicated monitoring elements or adding a wiring construction to product elements, it is possible to carry out measurement at a large number of positions easily and in a comparatively short time. By properly feeding back the measurement results into the manufacturing process, it is possible to stabilize the form of the magnetic poles of the manufactured products. Although materials that are susceptible to corrosion are normally used as the magnetic pole material, since the resistance of the magnetic pole will change when corrosion has occurred, it is also possible to detect whether corrosion has occurred using the present embodiment. The quality of products can therefore also be improved.

### BRIEF DESCRIPTION OF THE DRAWINGS

FIG. 1 is a diagram useful in explaining a recording/reproducing apparatus (i.e., a magnetic head);

FIG. 2 is a plan view useful in showing a monitoring element;

FIG. 3 is a diagram useful in showing main magnetic poles that are shaped in the form of an inverted triangle and an inverted trapezoid;

FIG. 4 is a diagram useful in explaining a case where the thickness of an insulating film is measured using an optical film thickness meter;

FIG. 5 is a plan view showing a construction where monitoring terminals are provided on a main magnetic pole;

FIG. 6 is a diagram useful in showing main magnetic poles with bilayer constructions that are inverted triangular and inverted trapezoidal in form; and

FIG. 7 is a diagram useful in explaining the machining of a cross section of a write magnetic pole.

### DESCRIPTION OF THE PREFERRED EMBODIMENTS

Preferred embodiments of the present invention will now be described in detail with reference to the attached drawings.

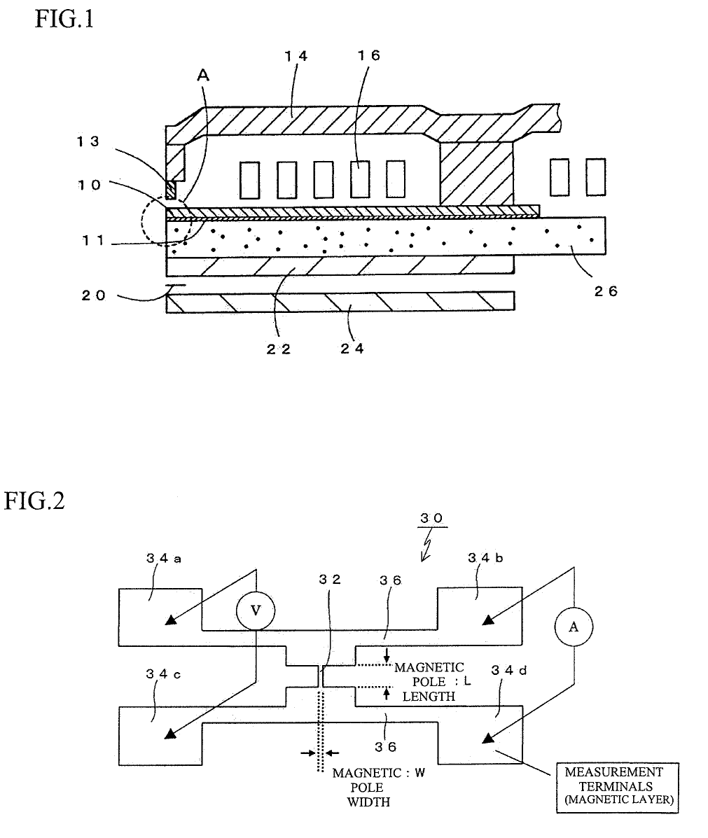

FIG. 1 is a cross-sectional view showing one example of a construction of a thin film magnetic head for perpendicular magnetic recording.

This thin film magnetic head includes, as a recording head, a main magnetic pole 10, a trailing shield 13, a return yoke 14, and a recording coil 16, and includes, as a reproduction head, an MR element 20, an upper shield 22, and a lower shield 24. Note that reference numeral 11 designates a plating base metal layer and the area marked “A” indicates a write front end portion of the main magnetic pole 10.

An insulating layer 26 made of alumina is provided between the upper shield 22 and the main magnetic pole 10, and insulating layers made of alumina or the like are provided between the main magnetic pole 10 and the recording coil 16, the recording coil 16 and the return yoke 14, and the MR element 20 and both the upper shield 22 and the lower shield 24.

In the thin film magnetic head described above, the shield layers 22, 24 and the MR element 20, the main magnetic pole 10, the coil 16, the return yoke 14, and the like are deposited in order so as to be laminated on an Al₂O₃—TiC substrate. After this, a row bar where a plurality of head elements are aligned in a row is cut out and the exposed laminated surface of the row bar is ground to form an air bearing surface including the (inverted triangular or inverted trapezoidal) cross section of the magnetic pole. The row bar is then further diced into individual heads.

In the present embodiment, when laminating and forming the main magnetic poles 10 of respective heads, at the same time as when the main magnetic poles 10 are formed, a plurality of monitoring elements 30 shown in FIG. 2 are produced as appropriate at positions aside from non-product positions on a magnetic recording head workpiece (i.e., substrate).

Each monitoring element 30 includes a monitoring magnetic pole 32 (a linear part in FIG. 2) that is formed with the same shape and the same material as the element magnetic pole of the magnetic recording head (i.e., the main magnetic pole 10) and four monitoring terminals 34a, 34b, 34c, and 34d that are electrically connected to the monitoring magnetic pole 32.

The monitoring terminals 34a, 34b, 34c, and 34d are electrically connected to the monitoring magnetic pole 32 by leads 36.

The monitoring terminals 34a, 34b, 34c, and 34d and the leads 36 may be fabricated at the same time as when the main magnetic pole 10 is formed using the same materials as the main magnetic pole 10.

The four monitoring terminals 34a, 34b, 34c, and 34d are disposed so that the monitoring terminals 34a and 34b and the monitoring terminals 34c and 34d form two pairs of terminals disposed on either side of the monitoring magnetic pole 32 (i.e., with the monitoring magnetic pole 32 in between).

The monitoring terminals 34a, 34b, 34c, and 34d are formed as large as possible to allow the terminals to be contacted by the front tips of measuring probes (not shown).

Note that four monitoring terminals do not need to be provided, and instead one monitoring terminal may instead be disposed on each side of the monitoring magnetic pole (i.e., a total of two terminals, not shown).

In the case of a main magnetic pole 10 with an inverted triangular cross-sectional form, measurement to find out whether the inverted triangular form has been produced as desired is carried out according to the following method.

First, at a stage where the monitoring elements 30 have been fabricated as shown in FIG. 2, that is, when the laminating process of the respective films has been completed, before the air bearing surface is formed by grinding, the width W of the upper edge of the monitoring magnetic pole 32 of each monitoring element 30 and the electrical resistance R at the position of the monitoring magnetic pole 32 are measured.

Since the monitoring magnetic pole 32 is exposed to the upper surface, the width W and the length L thereof can be easily measured. The electrical resistance of the monitoring magnetic pole 32 can be easily measured by a four-probe method. Since the cross-sectional area of the monitoring magnetic pole 32 is extremely small compared to the monitoring terminals 34a, 34b, 34c, and 34d and the leads 36, the resistances of the monitoring terminals and leads can be ignored, and therefore the electrical resistance measured by the four probe method can be regarded as the resistance of the monitoring magnetic pole 32.

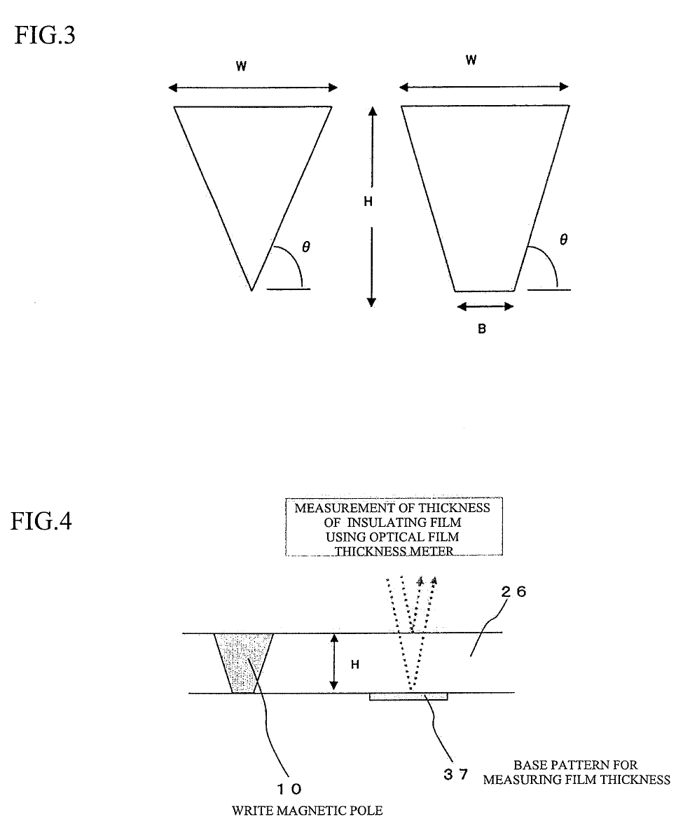

In the case of an inverted-triangular main magnetic pole, since R=ρL/S and S=WH/2, the height H and angle θ (FIG. 3) of the magnetic pole can be easily calculated according to the following equations.

H=2ρL/WR

θ=tan⁻¹(2H/W)

ρ: resistivity of magnetic pole material (fixed value)
L: length of magnetic pole portion of monitoring element (fixed value)
R: resistance of monitoring element (measured value)
W: width of the upper surface of magnetic pole (measured value)
H: height of magnetic pole (calculated value)
θ: inclined angle of magnetic pole side surface (calculated value)
S: cross-sectional area of magnetic pole (calculated value)

As described above, since the width W of the upper edge, the height H, and the angle θ of the main magnetic pole 10 with an inverted triangular cross-sectional form can be measured or calculated, it is possible to determine whether the form of the manufactured main magnetic pole 10 is the desired form.

In the present embodiment, it is possible to know the form of the magnetic pole without destroying an element. By fabricating a large number of dedicated monitoring elements 30, it is possible to carry out measurement at a large number of positions easily and in a comparatively short time. By properly feeding back the measurement results into the manufacturing process, it is possible to stabilize the form of the magnetic poles of the manufactured products. Although materials that are susceptible to corrosion are normally used as the magnetic pole material, since the resistance of the magnetic pole will change when corrosion has occurred, it is also possible to detect whether corrosion has occurred using the present embodiment. The quality of products can therefore also be improved.

However, when the main magnetic pole 10 has an inverted trapezoidal cross-sectional form, by merely measuring the electrical resistance of the monitoring magnetic pole 32, it is not possible to directly calculate the height H of the inverted trapezoid because such resistance is also related to the width B of the lower edge of the inverted trapezoid.

For this reason, in the present embodiment, as shown in FIG. 4, a base pattern 37 for measuring the film thickness is formed on a lower surface of the insulating layer 26 in the periphery of the main magnetic pole 10. Then, by using a well-known optical film thickness meter, the thickness of the insulating layer 26 is measured for example by measuring the interference pattern between the light reflected from the upper surface of the insulating layer 26 and the light reflected from the upper surface of the base pattern 37. By doing so, the height of the main magnetic pole 10 (or the monitoring magnetic pole 32) is measured.

The width B of the lower edge and the angle θ of the inverted trapezoidal main magnetic pole 10 can be calculated according to the following equations.

B=2ρL/HR−W

θ=tan⁻¹(2H/(W−B))

ρ: resistivity of magnetic pole material (fixed value)
L: length of magnetic pole portion of monitoring element (fixed value)
R: resistance of monitoring element (measured value)
W: width of upper surface of magnetic pole (measured value)
H: height of magnetic pole (measured value)
θ: inclined angle of magnetic pole side surface (calculated value)
B: width of bottom surface of (inverted trapezoidal) magnetic pole (calculated value)
S: cross-sectional area of magnetic pole (calculated value)

As described above, since the width W of the upper edge, the width B of the lower edge B, the height H, and the angle θ of the inverted trapezoidal main magnetic pole 10 can be measured or calculated, it is possible to determine whether the form of the main magnetic pole 10 has been manufactured in the desired form.

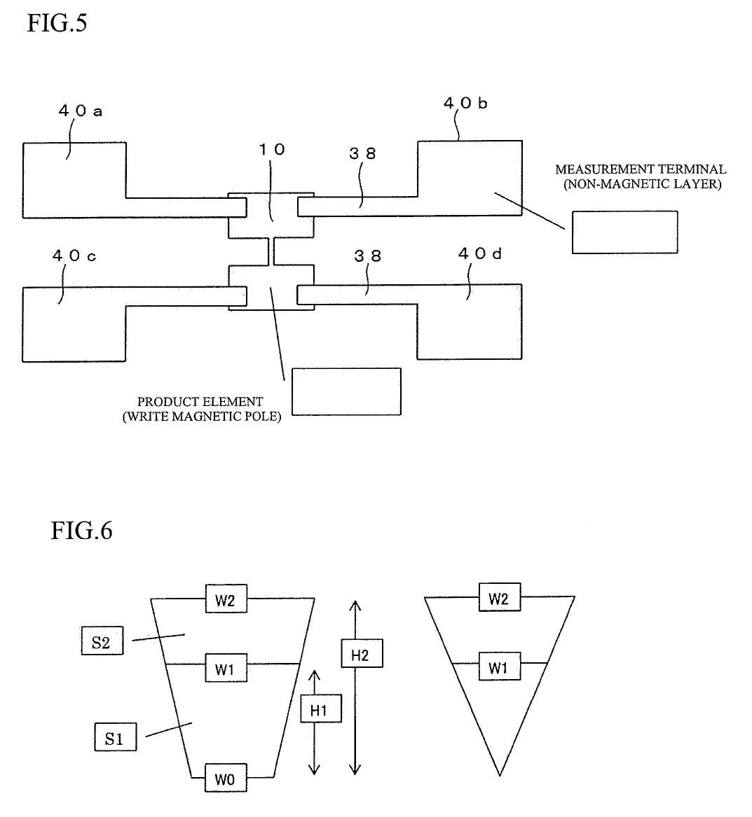

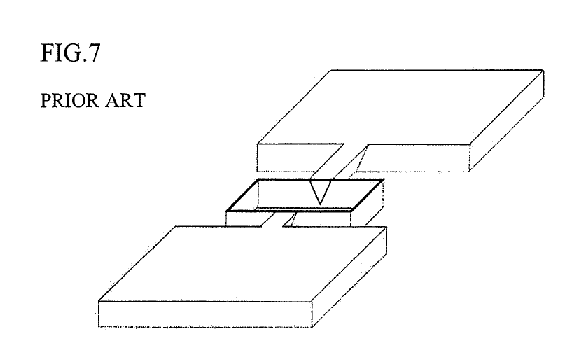

Although the monitoring elements 30 are formed in the present embodiment described above, as shown in FIG. 5, it is also possible to form monitoring terminals 40a, 40b, 40c, and 40d that are electrically connected via leads 38 to the main magnetic pole 10 on the main magnetic pole 10 itself without producing the monitoring elements. By using these monitoring terminals 40a, 40b, 40c, and 40d, it is possible to determine the cross-sectional form (inverted triangular or inverted trapezoidal) of the main magnetic pole 10 using the four probe method in the same way as described above.

Note that in this case, the material of the leads 38 and the monitoring terminals 40a, 40b, 40c, and 40d should be non-magnetic. Since half of the leads and monitoring terminals will remain at parts that become the manufactured products after the grinding of the air bearing surface, if such components were formed of a magnetic material in the same way as the main magnetic pole, there would be the risk of leaking magnetic flux being produced, which is unfavorable.

The main magnetic pole 10 does not necessarily have a single-layer construction and may have a multilayer construction composed of different magnetic materials. In this case, since there will be no large difference in the resistivity p even when different magnetic materials are used, by using an average value as the resistivity p, for example, it is possible to regard the magnetic pole as having a single-layer construction and to detect the cross-sectional form in the same way as described above.

Note that an example where the form of the main magnetic pole is determined by measurement and calculation for the case where the main magnetic pole (i.e., the write magnetic pole) 10 has a bilayer construction and the resistivity of the respective layers is ρ1, ρ2 (i.e., not an average value) is described below.

The symbols used in FIG. 6 and the like are as follows.

| | | |
|---|---|---|
| Film thickness | First layer (lower layer) | H1 (measured value) |
| | Combination of first and second layer | H2 (measured value for |
| | | a trapezoidal form) |
| Width | Lower edge (for a trapezoidal form) | W0 |
| | Upper edge of first layer (lower layer) | W1 |
| | Upper edge of second layer (upper layer) | W2 (measured value) |
| Magnetic pole length | | L (fixed value) |
| Resistivity | First layer (lower layer) | ρ1 (fixed value) |
| | Second layer (upper layer) | ρ2 (fixed value) |
| Area of cross section | First layer (lower layer) | S1 |
| | Second layer (upper layer) | S2 |
| Resistance of length L | First layer (lower layer) | R1 = ρ1L/S1 |
| | Second layer (upper layer) | R2 = ρ2L/S2 |
| | Multilayer | R = R1 · R2/(R1 + R2) = |
| | | ρ1ρ2L/(ρ1S2 + ρ2S1) |
| | | (measured value) |

1) Case where the Cross-Sectional Form of the Main Magnetic Pole is Inverted Trapezoidal (where Respective Thicknesses of Laminated Films can be Measured)

$$\begin{matrix} {W}_{1} = \frac{{H}_{1}}{{H}_{2}} {W}_{2} + \frac{{H}_{2} - {H}_{1}}{{H}_{2}} {W}_{0} & Equation 1 \\ {S}_{1} = \frac{1}{2} ( {W}_{0} + {W}_{1} ) {H}_{1} = \frac{{H}_{1}^{2}}{2 {H}_{2}} {W}_{2} + \frac{{H}_{1} ( 2 {H}_{2} - {H}_{1} )}{2 {H}_{2}} {W}_{0} & Equation 2 \\ {S}_{2} = \frac{1}{2} ( {W}_{1} {W}_{2} ) ( {H}_{2} - {H}_{1} ) = \frac{{H}_{2}^{2} - {H}_{1}^{2}}{2 {H}_{2}} {W}_{2} + \frac{{( \begin{matrix}{H}_{2} - \\ {H}_{1}\end{matrix} )}^{2}}{2 {H}_{2}} {W}_{0} & Equation 3 \\ \begin{matrix} R = \frac{{R}_{1} \cdot {R}_{2}}{{R}_{1} + {R}_{2}} \\ = \frac{{ρ}_{1} {ρ}_{2} L}{{ρ}_{1} {S}_{2} + {ρ}_{2} {S}_{1}} \\ = \frac{2 {ρ}_{1} {ρ}_{2} {LH}_{2}}{{ρ}_{1} \{ \begin{matrix}( {H}_{2}^{2} - {H}_{1}^{2} ) {W}_{2} + \\ {( {H}_{2} - {H}_{1} )}^{2} {W}_{0}\end{matrix} \} + {ρ}_{2} \{ \begin{matrix}{H}_{1}^{2} {W}_{2} + \\ {H}_{1} ( 2 {H}_{2} - {H}_{1} ) {W}_{0}\end{matrix} \}}\end{matrix} & Equation 4\end{matrix}$$

Solving the above equation for W0 gives Equation 5.

$${W}_{0} = \frac{2 {ρ}_{1} {ρ}_{2} {LH}_{2} - {RW}_{2} \{ {ρ}_{1} ( {H}_{2}^{2} - {H}_{1}^{2} ) + {ρ}_{2} {H}_{1}^{2} \}}{R \{ {{ρ}_{1} ( {H}_{2} + {H}_{1} )}^{2} + {ρ}_{2} {H}_{1} ( 2 {H}_{2} - {H}_{1} ) \}} \qquad Equation 5$$

Angle θ is as follows.

$$θ = {tan}^{- 1} ( \frac{2 {H}_{2}}{{W}_{2} - {W}_{0}} ) \qquad Equation 6$$

From W2, W0, H2, and θ, it is possible to determine the form of the inverted trapezoid.

2) Case where the Cross-Sectional Form of the Main Magnetic Pole is Inverted Triangular (where the Thickness of the Lower Layer Out of the Laminated Films can be Measured)

$$\begin{matrix}{W}_{1} = \frac{{H}_{1}}{{H}_{2}} {W}_{2} & Equation 7 \\ {S}_{1} = \frac{1}{2} {W}_{1} {H}_{1} = \frac{{H}_{1}^{2}}{2 {H}_{2}} {W}_{2} & Equation 8 \\ \begin{matrix}{S}_{2} = \frac{1}{2} ( {W}_{1} + {W}_{2} ) ( {H}_{2} - {H}_{1} ) \\ = \frac{{H}_{2}^{2} - {H}_{1}^{2}}{2 {H}_{2}} {W}_{2}\end{matrix} & Equation 9 \\ \begin{matrix}R = \frac{{R}_{1} \cdot {R}_{2}}{{R}_{1} + {R}_{2}} \\ = \frac{{ρ}_{1} {ρ}_{2} L}{{ρ}_{1} {S}_{2} + {ρ}_{2} {S}_{1}} \\ = \frac{2 {ρ}_{1} {ρ}_{2} {LH}_{2}}{{W}_{2} \{ {ρ}_{1} ( {H}_{2}^{2} - {H}_{1}^{2} ) + {ρ}_{2} {H}_{1}^{2} \}}\end{matrix} & Equation 10\end{matrix}$$

Solving the above equation for H2 gives Equation 11.

$${H}_{2} = \frac{{ρ}_{1} {ρ}_{2} L \pm \sqrt{{ρ}_{1}^{2} {ρ}_{2}^{2} {L}^{2} - {R}^{2} {ρ}_{1} ( {ρ}_{2} - {ρ}_{1} ) {W}_{2}^{2} {H}_{1}^{2}}}{R {ρ}_{1} {W}_{2}} \qquad Equation 11$$

Angle θ is as follows.

$$θ = {tan}^{- 1} ( \frac{2 {H}_{2}}{{W}_{2}} ) \qquad Equation 12$$

From W2, H2, and θ, it is possible to determine the form of the inverted triangle.

Although an example of a perpendicular magnetic head has been described above, it is also possible to apply the present invention to a magnetic head for horizontal recording.

What is claimed is:

1. A monitoring element for a magnetic recording head that is formed on a workpiece for magnetic recording heads on which element magnetic poles of the magnetic recording head are formed, the monitoring element comprising:
a monitoring magnetic pole formed of a same material and in a same form as the element magnetic poles; and
monitoring terminals that are electrically connected to the monitoring magnetic pole.

2. A monitoring element for a magnetic recording head according to claim 1,
wherein the monitoring terminals are formed of the same material as the monitoring magnetic pole.

3. A monitoring element for a magnetic recording head according to claim 1,
wherein the monitoring terminals are composed of four terminals that are disposed so that two monitoring terminals are positioned on either side of the monitoring magnetic pole.

4. A method of manufacturing a magnetic recording head formed with an air bearing surface including a cross-section of a magnetic pole that has been subjected to a grinding process after formation of the magnetic pole, the method comprising:
a step of measuring a resistance of the magnetic pole before the grinding process;
a step of measuring a width of an upper edge of the magnetic pole; and
a step of calculating a cross-sectional form using the width of the upper edge and the resistance of the magnetic pole.

5. A method of manufacturing a magnetic recording head according to claim 4,
wherein the cross section of the magnetic pole is in the form of an inverted triangle.

6. A method of manufacturing a magnetic recording head according to claim 4,
wherein the cross section of the magnetic pole is in the form of an inverted trapezoid and the method further comprises:
a step of measuring a film thickness of the magnetic pole; and
a step of calculating a cross-sectional form using the width of the upper edge, the resistance, and the film thickness of the magnetic pole.

7. A method of manufacturing a magnetic recording head according to claim 6,
wherein the film thickness is measured optically.

8. A method of manufacturing a magnetic recording head according to claim 4,
wherein the resistance is measured by a four probe method.

9. A method of measuring the form of a magnetic pole of a magnetic recording head, the method comprising:
a step of measuring a resistance of the magnetic pole;
a step of measuring a width of an upper edge of the magnetic pole; and
a step of calculating a cross-sectional form using the width of the upper edge and the resistance of the magnetic pole.

10. A method of measuring the form of a magnetic pole according to claim 9,
wherein the cross section of the magnetic pole is in the form of an inverted triangle.

11. A method of measuring the form of a magnetic pole according to claim 9,
wherein the cross section of the magnetic pole is in the form of an inverted trapezoid and the method further comprises:
a step of measuring a film thickness of the magnetic pole; and
a step of calculating a cross-sectional form using the width of the upper edge, the resistance, and the film thickness of the magnetic pole.

12. A method of measuring the form of a magnetic pole according to claim 11,
wherein the film thickness is measured optically.

13. A method of measuring the form of a magnetic pole according to claim 9,
wherein the resistance is measured by a four probe method.
